(19) United States
(12) Patent Application Publication
(10) Pub. No.: US 2022/0292606 A1
(43) Pub. Date: Sep. 15, 2022

(54) SYSTEMS AND METHODS FOR GENERATING AND DISPLAYING MODELS FOR VEHICLE ROUTES USING A MACHINE LEARNING ENGINE

(71) Applicant: Capital One Services, LLC, McLean, VA (US)

(72) Inventors: Chih-Hsiang CHOW, Coppell, TX (US); Elizabeth FURLAN, Plano, TX (US); Steven DANG, Bellevue, WA (US)

(73) Assignee: Capital One Services, LLC, McLean, VA (US)

(21) Appl. No.: 17/195,897

(22) Filed: Mar. 9, 2021

(51) Int. Cl. G06Q 40/08; G06Q 30/02; G06N 20/00; G06N 3/04

(52) U.S. Cl. CPC G06Q 40/08; G06Q 30/0206; G06N 20/00; G06N 3/04

(57) ABSTRACT

Disclosed are systems and methods for generating and displaying models for routes using a machine learning engine. The method may include: receiving a plurality of route data sets, each associated with a route; determining a route score for each route; receiving a plurality of driver data sets, each associated with a driver; determining a driver score for each driver; generating a model for each driver based on a respective driver score and a respective route score; grouping the route data sets into clusters; training a neural network to associate each cluster with one or more sequential patterns found within the cluster; receiving a first driver data set and a first route data set; generating a first route score and a first driver score; generating, a first model based on the first route score and the first driver score.

### TECHNICAL FIELD

Various embodiments of the present disclosure relate generally to vehicle route risk models and, more particularly, to systems and methods for generating vehicle route risk models and causing display of corresponding graphics using a machine learning engine.

### BACKGROUND

The amount of data collected regarding drivers of vehicles and their behaviors is constantly increasing. Between mobile phones utilizing global positioning services (GPS) for map applications and connected devices embedded directly in modern vehicles, there likely exists a wealth of information about any given individual's particular driving habits. There likely also exists a wealth of information about the roads in any given geographical area. However, many navigation systems and other driving systems rely on time and distance information, to the exclusion of other relevant information, for selecting routes for drivers. The navigation systems and other driving systems therefore do not harness available and relevant information and thus fail to optimize route selection.

The present disclosure is directed to addressing the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for generating vehicle route risk models using a machine learning engine.

In one example, a computer-implemented method for generating and displaying models for routes using a machine learning engine may include: receiving, by one or more processors, a plurality of route data sets, wherein each route data set in the plurality of route data sets may be associated with a route, and wherein each route data set may include associated collision data; determining, by the one or more processors, a route score for each of the associated routes; receiving, by the one or more processors, a plurality of driver data sets, wherein each driver data set in the plurality of driver data sets may be associated with a driver, and wherein each driver data set may comprise a driver history for a driver; determining, by the one or more processors, a driver score for each of the associated drivers; generating, by the one or more processors, a model for each driver and each route based on a respective driver score and a respective route score; grouping the plurality of the route data sets, by the one or more processors, into one or more clusters of route data sets based on the model; for each of the one or more clusters, training a neural network, by the one or more processors, to associate the cluster with one or more sequential patterns found within the cluster, based on one or more route data sets in the cluster of the plurality of route data sets, to generate a trained neural network; receiving a first driver data set and a first route data set, wherein the first driver data set may be associated with a first driver, and the first route data set may be associated with a first route of the first driver; inputting, by the one or more processors, the first driver data set and the first route data set into the trained neural network; generating, using the trained neural network, by the one or more processors, a first route score based on the first route data set and a first driver score based on the first driver data set; generating, using the trained neural network, by the one or more processors, a first model based on the first route score and the first driver score; and causing display, by the one or more processors, of a graphic representing the first model on an interface.

In another example, a computer system for generating and displaying models for routes using a machine learning engine may include: a memory having processor-readable instructions stored therein; and at least one processor configured to access the memory and execute the processor-readable instructions, which when executed by the at least one processor configures the at least one processor to perform a plurality of functions. The plurality of functions may include: receiving a plurality of route data sets, wherein each route data set in the plurality of route data sets may be associated with a route, and wherein each route data set may include associated collision data and collision repair cost data; determining a route score for each of the associated routes; receiving a plurality of driver data sets wherein each driver data set in the plurality of driver data sets may be associated with a driver, and wherein each driver data set may comprise a driver history for a driver; determining a driver score for each of the associated drivers; generating a model for each driver and each route based on a respective driver score and a respective route score; grouping the plurality of the route data sets into one or more clusters of route data sets based on the model; for each of the one or more clusters, training a neural network to associate the cluster with one or more sequential patterns found within the cluster, based on one or more route data sets in the cluster of the plurality of route data sets, to generate a trained neural network; receiving a first driver data set and a first route data set, wherein the first driver data set may be associated with a first driver, and the first route data set is associated with a first route of the first driver; inputting the first driver data set and the first route data set into the trained neural network; generating, using the trained neural network, a first route score based on the first route data set and a first driver score based on the first driver data set; generating, using the trained neural network, a first model based on the first route score and the first driver score; and causing display of a graphic representing the first model on an interface.

In yet another example, an embodiment of a computer-implemented method for generating and displaying models for routes using a machine learning engine may include: receiving, by one or more processors, a plurality of route data sets, wherein each route data set in the plurality of route data sets may be associated with a route, and wherein each route data set may include associated collision data and collision repair cost data; determining, by the one or more processors, a route score for each of the associated routes; receiving, by the one or more processors, a plurality of driver data sets wherein each driver data set in the plurality of driver data sets may be associated with a driver, and wherein each driver data set may comprise a driver history for a driver; determining, by the one or more processors, a driver score for each of the associated drivers; generating, by the one or more processors, a model for each driver and each route based on a respective driver score and a respective route score; grouping the plurality of the route data sets, by the one or more processors, into one or more clusters of route data sets based on the model; for each of the one or more clusters, training a neural network, by the one or more processors, to associate the cluster with one or more sequential patterns found within the cluster, based on one or more route data sets in the cluster of the plurality of route data sets, to generate a trained neural network; receiving a first driver data set and a first route data set, wherein the first driver data set may be associated with a first driver, and the first route data set is associated with a first route of the first driver; inputting, by the one or more processors, the first driver data set and the first route data set into the trained neural network; generating, using the trained neural network, by the one or more processors, a first route score based on the first route data set and a first driver score based on the first driver data set; generating, using the trained neural network, by the one or more processors, a first model based on the first route score and the first driver score; receiving a second route data set, wherein the second route data set may be associated with a second route of the first driver; inputting, by the one or more processors, the first driver data set and second route data set into the trained neural network; generating, using the trained neural network, by the one or more processors, a second route score based on the second route data set; generating, using the trained neural network, by the one or more processors, a second model based on the second route score and the first driver score; and inputting or transmitting the first model and the second model to a route selection system, the route selection system being configured to select one of the first route and the second route based on the first model and the second model.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary computing environment that may be used with one or more embodiments.

FIG. 2 depicts a flowchart of an exemplary method of training a machine learning engine, according to one or more embodiments.

FIG. 3 depicts a flowchart of an exemplary method of using a trained machine learning engine to generate a risk model and cause display of a corresponding graphic, according to one or more embodiments.

FIG. 4 depicts an exemplary map including routes which a machine learning engine may be capable of analyzing, according to one or more embodiments.

FIG. 5 depicts an example chart representative of an analysis performed by a machine learning engine, according to one or more embodiments.

FIG. 6 depicts an example of a graphic which may be representative of a risk model, according to one or more embodiments.

FIG. 7 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

As used herein, the terms “route,” “routes,” or the like generally encompass one or more of: a path from a first geographic location to a second geographic location along roads, streets, highways, or the like; a set of paths from a first geographic location to a second geographic location along roads, streets, highways, and the like; and a collection of roads, streets, highways, and the like existing within a geographic area.

In general, the present disclosure provides methods and systems for generating vehicle route risk models and more particularly to methods and system for generating vehicle route risk models using a machine learning engine and causing display of graphics representative of those risk models on an interface. As will be discussed hereinafter in more detail, methods and systems according to the present disclosure offer significant technical advantages.

Data relating to driver behaviors and tendencies has become relatively rich in recent years, due at least in part to data collection by mobile phones that drivers may carry when driving, and also due in part to data collection by on-board computers in modern vehicles. Mobile phones and on-board computers may, for example, use GPS to pinpoint a vehicle's location at any given time and store an electronic record of the vehicle's location over time. Depending on the applications or services used by a driver on their mobile phone or on their on-board computer, the mobile phone or on-board computer may transmit data representing a record of that location, and other locations, on a continuous basis, to various databases. The data transmitted may further include other information such as, for example, vehicle speed, time, local weather, or any other information items. Consequently, there may be a wealth of information relating to any particular driver's behaviors existing in one or more databases at any moment.

Data relating to particular routes, roadways, and geographical areas has also become richer in recent years. Map applications and other types of applications may collect data about traffic patterns, traffic density, accidents, and pedestrian density, among other types of data relevant to driving and safety. Map applications may gather this data by aggregating data for individual users or by prompting individual users to manually enter information.

Existing navigation systems and other driving systems generally fail to make use of this data to optimize route selection. For example, existing navigation systems and other driving systems may use traffic information when accounting for how long it may take to travel a particular route, but the systems generally do not use the information to account for how risky a route is or how likely a driver is to be in an accident along the route. Route risk is generally not a factor for route selection using these systems.

Existing vehicle insurance services also generally fail to make substantial use of the large quantities of data available for any given driver or data available for particular routes. As a result, vehicle insurance services may persist in offering generally inflexible and untailored coverage policies. Vehicle insurance services may continue to base their policies and premium rates on generalized data and actuarial tables in connection with self-reported annual driving mileage, driving records, types of vehicles driven, and general location. The vehicle insurance services may therefore neglect the wealth of more specific data that relate to individual drivers and individual routes.

As an example, vehicle insurance services may fail to account for the fact that certain drivers may engage in safer driving behaviors than other drivers, as indicated by the data, including driving relatively safer routes or in relatively safer geographical areas. The safer drivers may nevertheless pay the same insurance premiums as less safe drivers, in effect subsidizing the insurance of the less-safe drivers.

This problem may be especially acute for rideshare drivers who attempt to generate an income by taxiing riders, either through a ridesharing application or otherwise. Such rideshare drivers may be required by law to purchase a type of business vehicle insurance policy, which may be more costly than a personal-use vehicle insurance policy. A rideshare driver with safer driving behaviors and who drives safer routes relative to other drivers may in effect be subsidizing the vehicle insurance of other less-safe drivers. By overpaying for their vehicle insurance policy, the safer rideshare may be sacrificing income from providing ridesharing services or, in more extreme scenarios, providing ridesharing services may become economically infeasible.

Accordingly, a need exists to address the foregoing challenges. Particularly, a need exists to make data relating to driving behavior, routes, and geographical areas more useable or usable for other applications, including navigation and insurance applications, among others. A need also exists for a platform through which route risk, which accounts for driving behavior and routes, can be visualized. Embodiments of the present disclosure offer technical solutions to address the foregoing needs, as well as other needs.

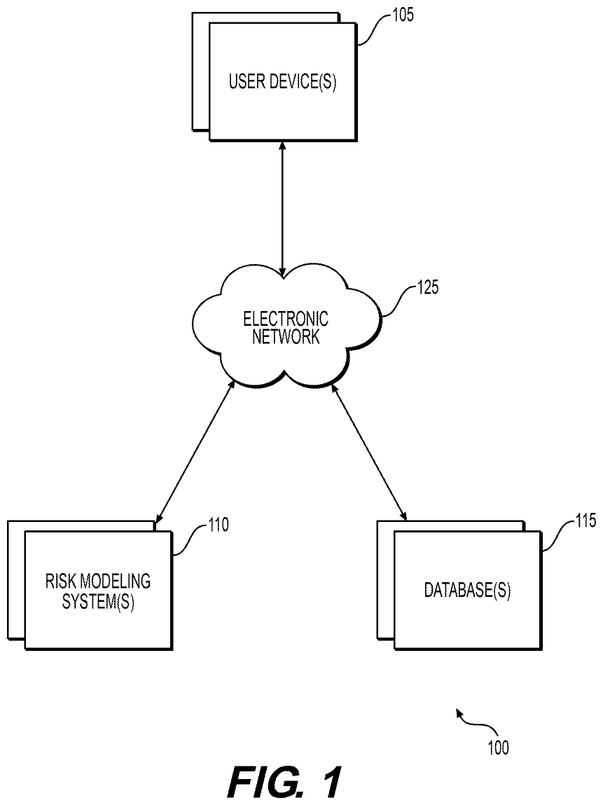

FIG. 1 depicts an exemplary computing environment 100 that may be utilized with techniques presented herein. One or more user device(s) 105 and one or more risk modeling system(s) 110 may communicate across an electronic network 125. One or more database(s) 115 may communicate with one or more of the other components of the computing environment 100. The systems and devices of the computing environment 100 may communicate in any arrangement. As will be discussed herein, systems and/or devices of the computing environment 100 may communicate in order to generate risk models for routes, display graphics representative thereof, and/or other actions.

The user device 105 may be a computer system such as, for example, a desktop computer, a mobile device, etc. In an exemplary embodiment, the user device 105 may be a mobile phone, or the like. Alternatively, the user device 105 may be an on-board computer in a vehicle. In some embodiments, the user device 105 may include one or more electronic application(s), e.g., a program, plugin, etc., installed on a memory of the user device 105. In some embodiments, the electronic application(s) may be associated with one or more of the other components in the computing environment 100. For example, the electronic application(s) may include a map application, a navigation application, a ridesharing application, or the like. The user device 105 may include a GPS module with a GPS chip for determining a geolocation of the user device 105. The user device 105 may further include a display and a user interface which may be a graphical user interface (GUI).

The database 115 may include data collected or generated by the user device 105 or the risk modeling system 110. The user device 105 may collect driver data associated with a driver. The driver data may include a driver history for the driver. The user device 105 may collect the driver data via a map application, a ridesharing application, or the like and transmit the driver data to the database 115. The driver data may include: routes driven by the driver indicated by, for example, GPS coordinates of the user device 105 over time; speeds driven by the driver; duration of trips; frequency of stops; acceleration and deceleration metrics; driver performance data; prior collision data; prior police citation data; and any other information indicative of a driver's driving behavior. The database 115 may arrange or index the data as driver data sets, where each driver data set is associated with a particular driver.

The database 115 may further include route data. The route data my include information concerning one or more routes that are drivable by a vehicle. The route data may include, for example: GPS coordinates for locations along the one or more routes; identifications of streets and roads; information about traffic along the one or more routes including traffic density; information about pedestrians along the one or more routes including pedestrian density; information about traffic lights along the one or more routes; information about speed limits and driver speeds along the one or more routes; information about weather and weather patterns along the one or more routes; information about vehicle collisions along the one or more routes, including location of each collision, type of each collision, repair cost of each collision; and any other information relevant to the one or more routes or driving along the one or more routes. The database 115 may arrange or index the data as route data sets, wherein each route data set is associated with a particular route.

In various embodiments, the electronic network 125 may be a wide area network (“WAN”), a local area network (“LAN”), personal area network (“PAN”), or the like. In some embodiments, electronic network 125 includes the Internet, and information and data provided between various systems occurs online. “Online” may mean connecting to or accessing source data or information from a location remote from other devices or networks coupled to the internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). In some embodiments, the electronic network 125 includes or is in communication with a telecommunications network, e.g., a cellular network.

The risk modeling system 110 may include a machine learning engine, which may be trained using various inputs. The machine learning engine may be a neural network or, more specifically, a convolutional neural network. As discussed in further detail below, the risk modeling system 110 may be configured to: determine route risk scores; determine driver risk scores; generate risk models for drivers and routes; group route data sets into clusters; train a neural network to associate clusters with patterns found in the clusters; generate risk models; and cause display of graphics representative of the risk models. In some embodiments, the risk modeling system 110 may include a memory that stores instructions and/or one or more machine-learning models, and/or other data, as discussed in further detail below.

Although depicted as separate components in FIG. 1, it should be understood that a component or portion of a component may, in some embodiments, be integrated with or incorporated into one or more other components. For example, a portion of the database 115 may be provided to the user device 105 as an electronic portal via the electronic application. At least a portion of risk modeling system 110 may be integrated into the database 115, the user device 105, or another system. Any suitable arrangement of the various systems and devices of the computing environment 100 may be used.

In the methods below, various acts are described as performed or executed by a component from FIG. 1, such as risk modeling system 110. However, it should be understood that in various embodiments, various components or combinations of components of the computing environment 100 discussed above may execute instructions or perform acts including the acts discussed below. Further, it should be understood that in various embodiments, various steps may be added, omitted, and/or rearranged in any suitable manner.

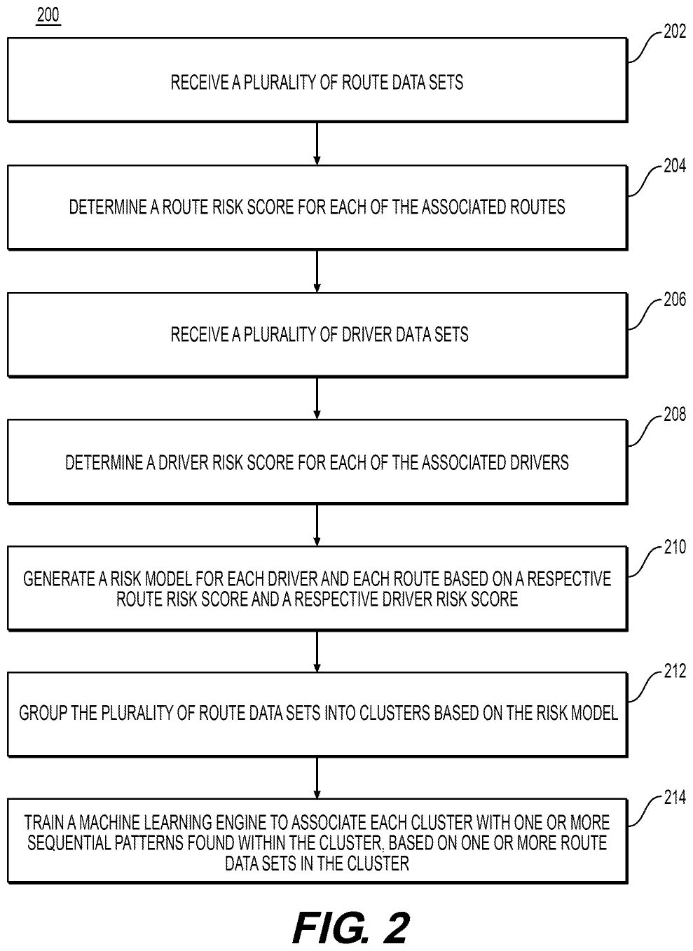

FIG. 2 depicts an exemplary process 200 for training a machine learning engine of the risk modeling system 110 that may be employed in some embodiments of the present disclosure. At step 202, the risk modeling system 110 may receive a plurality of route data sets. Each route data set may be associated with a route. The risk modeling system 110 may receive the plurality of route data sets from one or more of the database(s) 115 depicted in FIG. 1. The risk modeling system 110 may receive the plurality of route data sets, for example, in response to querying a mapping service such as Google Maps, Apple Maps, a public records database, or any combination of these or other data sources. The risk modeling system 110 may also receive one or more of the plurality of route data sets as a result of a user manually uploading the route data sets via user device 105. The risk modeling system 110 may store the plurality of route data sets in a designated storage location.

Each of the plurality of route data sets may include: locations along the one or more routes identified by GPS coordinates or the like; identifications of streets, roads, highways, and the like; information about traffic along the one or more routes including traffic density; information about pedestrians along the one or more routes including pedestrian density and incidents of pedestrian collisions; information about traffic lights along the one or more routes; information about speed limits and driver speeds along the one or more routes; information about weather and weather patterns along the one or more routes; information about vehicle collisions along the one or more routes, including a location of each collision, frequency of collisions, type of each collision, type of vehicle involved in each collision, repair cost of each collision, and/or estimated repair cost of each collision; and any other information relevant to the one or more routes.

At step 204, the risk modeling system 110 may determine a route risk score for each route associated with one of the plurality route data sets. The risk modeling system 110 may determine the route risk score for a route based on one or more of the data in the route data set associated with the route. The risk modeling system 110 may further determine the route risk score by applying a computer algorithm utilizing various weighting and/or biasing techniques to the one or more data in the route data set. For example, the risk modeling system 110 may determine a route risk score based on vehicle collisions along the route, including the types of each collision, frequency of collisions, and repair cost of each collision. The risk modeling system 110 may alternatively determine a route risk score based on vehicle collisions along the route, traffic density along the route, and incidents of pedestrian collisions. Each route risk score may therefore be indicative of a general risk of that a vehicle will be in an accident along a route. It is to be understood that the risk modeling system 110 may determine each route risk score based on any subset of the data in each route data set, and should not be limited to any particular examples described herein.

At step 206, the risk modeling system 110 may receive a plurality of driver data sets. Each driver data set may be associated with a driver, where a driver may be a user of the user device 105. Each of the plurality of driver data sets may comprise a driver history for the driver, including: routes driven by the driver indicated by, for example, GPS coordinates of the user device 105 plotted over time, speeds driven by the driver, driving duration, frequency of stops, acceleration and deceleration metrics, driver performance data, prior collision data for the driver, prior police citation data for the driver, and any other information indicative of a driver's driving behavior. A driver data set need not comprise an entire driver history for a driver and instead may comprise a subset of the driver's driver history. For example, a driver data set may comprise data from a predetermined number of trips or may comprise data from a predetermined time period. In the event that a driver data set includes less than a driver's full driver history, known statistical techniques may be used with the data in the driver data set, for example, to extrapolate the data over a desired time period. Moreover, an individual driver data set need not necessarily be received by the risk modelling system 110 all at once. The risk modelling system 110 may receive a driver data set as a plurality of subsets of data and may further receive each of the plurality of subsets of data sequentially.

The risk modeling system 110 may receive the plurality of driver data sets from one or more of the database(s) 115 depicted in FIG. 1. The risk modeling system 110 may receive the plurality of driver data sets, for example, in response to querying a mapping service such as Google Maps, Apple Maps, a public records database, or any combination of these or other data sources. The risk modeling system 110 may additionally receive the plurality of driver data sets, for example, in response to querying a ridesharing service such as Uber, Lyft, or the like. The risk modeling system 110 may additionally receive the plurality of driver data sets, for example, in response to a user of the user device 105 manually entering a driver data set into the user device 105 or causing the driver data set to be uploaded from the user device 105. The risk modeling system 110 may additionally receive the plurality of driver data sets, for example, as a result of analysis of receipts from a ridesharing app, where the analysis could include text recognition, image recognition, or the like. The risk modeling system 110 may store the plurality of driver data sets in a designated database.

At step 208, the risk modeling system 110 may determine a driver risk score for each driver associated with one of the driver data sets. The risk modeling system 110 may determine the driver risk score for a driver based on one or more of the data in the driver data set corresponding to the route. The risk modeling system 110 may determine the driver risk score by applying a computer algorithm utilizing various weighting and/or biasing techniques to the one or more data in the driver data set. For example, the risk modeling system 110 may determine a driver risk score based on speeds driven by the driver, prior collision data for the driver, and prior police citation data for the driver. Each driver risk score may therefore be indicative of a general risk that a driver will be in an accident. It is to be understood that the risk modeling system 110 may determine each driver risk score based on any of the data in each driver data set, and should not be limited to any particular examples described herein.

At step 210, the risk modeling system 110 may generate a risk model for the various combinations of drivers and routes, the risk modeling system 110 having received an associated driver data set for each driver and an associated route data set for each route. The risk modeling system 110 may generate the risk model based on the driver risk score for the driver in each combination and the route risk score for the route in each combination. The risk modeling system 110 may further generate the risk model by applying a computer algorithm utilizing various weighting and/or biasing techniques to each combination of a driver risk score and a route risk score. Each risk model may therefore be indicative of a risk that a particular driver driving on a particular route will be in an accident on the particular route and/or that a cost will be associated with the accident to, for example, pay for repairs to a vehicle or the like.

At step 212, the risk modeling system 110 may group the plurality of route data sets into one or more clusters of route data sets. Any known clustering technique may be used, including for example hierarchical clustering, centroid-based clustering, distribution-based clustering, density-based clustering, and grid-based clustering. The parameter settings for the clustering are not particularly limited, and may include various settings for a distance function, a density threshold, or a number of expected clusters. The risk modeling system 110 may perform the clustering based on the risk models generated for each of the respective combinations of drivers and routes. For example, for each route data set that is grouped, the risk modelling system 110 may account for one or more risk models generated for the route data set and each of the respective drivers according to step 210. In some embodiments, the risk modelling system 110 may group indicators of each of the plurality of route data sets, as opposed to the route data sets themselves, where the indicators are indexed to respective route data sets or routes.

After grouping the plurality of route data sets into one or more clusters of route data sets, the risk modeling system 110 may, at step 214, train the machine learning engine based on the clusters as input data to generate a trained machine learning engine. As discussed herein previously, the machine learning engine may be a neural network or a convolutional neural network and the result of the training may therefore be a trained neural network or a trained convolutional neural network. The risk modeling system 110 may train the machine learning engine to associate each cluster with one or more characteristics using known data mining techniques. As an example, the risk modeling system 110 may train the machine learning engine to find statistically relevant patterns within each cluster and associate each cluster with the one or more patterns. In some embodiments, the machine learning engine may search for sequential patterns. At least one goal of training the machine learning engine according to the foregoing process 200 is to train the machine learning engine to associate characteristics of a driver (found in, for example, a driver data set) and characteristics of a route (found in, for example, a route data set) with a risk that the driver will be in an accident on the route and/or that a cost will be associated with the accident to, for example, pay for repairs to a vehicle or the like.

It is to be understand that the clustering and association described herein previously with respect to steps 212 and 214 represent an example of how the machine learning engine of risk modeling system 110 may be trained. In some embodiments, other known methods of training a machine learning engine, including other supervised or unsupervised learning techniques, may be used to form associations between route data sets or routes associated with the route data sets and one or more characteristics of interest, including characteristics relating to, or indicative of, risk of an accident and/or a potential cost of the accident.

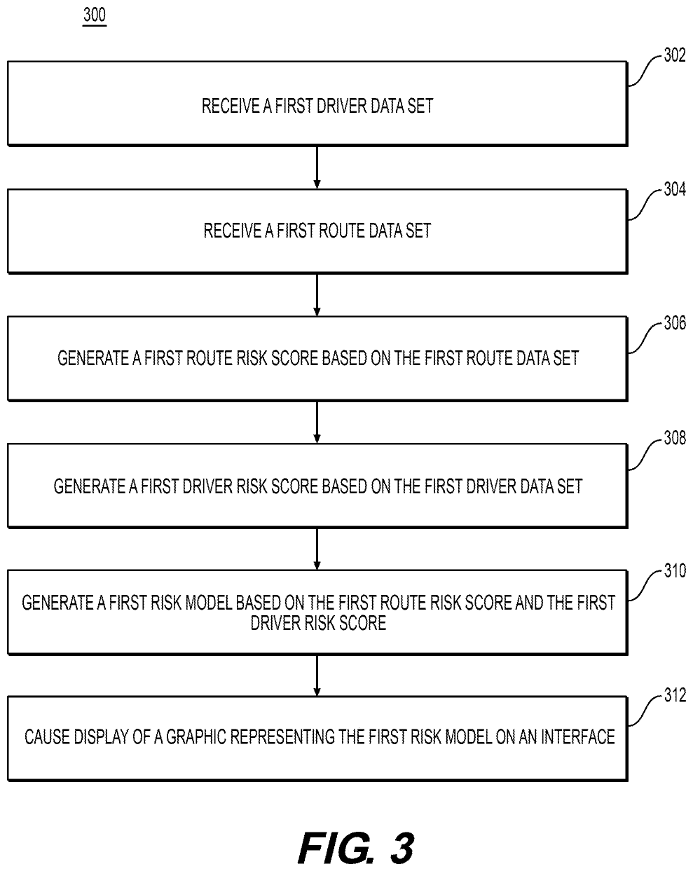

FIG. 3 depicts an exemplary process 300 of using the trained machine learning engine of risk modeling system 110 to generate a first risk model and cause display of a corresponding graphic on a user interface. At step 302, the risk modeling system 110 may receive a first driver data set. Similar to the plurality of driver data sets described herein previously, the first driver data set may be associated with a driver, where the driver may be a user of the user device 105. The first driver data set may comprise a driver history for the driver, including: routes driven by the driver indicated by, for example, GPS coordinates of the user device 105 plotted over time, speeds driven by the driver, driving duration, frequency of stops, acceleration and deceleration metrics, driver performance data, prior collision data for the driver, prior police citation data for the driver, and any other information indicative of the driver's driving behavior. The driver may cause the first driver data set to be received by the risk modeling system 110 by, for example, the driver initiating an upload process via a user interface of user device 105. The first driver data set may be received from any of the sources discussed herein previously with respect to the plurality of driver data sets.

At step 304, the risk modeling system 110 may receive a first route data set. The first route data set may be associated with a route, where the route is, for example, identified in the first driver data set as a route driven by the driver, manually selected by the driver, or any other route. The first route data set may include: locations along the one or more routes identified by GPS coordinates or the like; identifications of streets, roads, highways, and the like; information about traffic along the one or more routes including traffic density; information about pedestrians along the one or more routes including pedestrian density and incidents of pedestrian collisions; information about traffic lights along the one or more routes; information about speed limits and driver speeds along the one or more routes; information about weather and weather patterns along the one or more routes; information about vehicle collisions along the one or more routes, including a location of each collision, frequency of collisions, type of each collision, type of vehicle involved in each collision, repair cost of each collision, and/or estimated repair cost of each collision; and any other information relevant to the one or more routes. The risk modeling system 110 may receive the plurality of route data sets from any one of the sources discussed herein previously with respect to the plurality of route data sets.

At step 306, the risk modeling system 110 may generate a first route risk score based on the first route data set. The risk modeling system 110 may generate the first route risk score by inputting the first route data set into the trained machine learning engine. The risk modeling system 110 may generate the first route risk score based on one or more of the data included within the first route data set. The first route risk score may therefore be indicative of a general risk of that a vehicle will be in an accident along the route associated with the first route data set.

At step 308, the risk modeling system 110 may generate a first driver risk score based on the first driver data set. The risk modeling system 110 may generate the first driver risk score by inputting the first driver data set into the trained machine learning engine. The risk modeling system 110 may generate the first driver risk score based on one or more of the data included within the first driver route set. The first driver risk score may therefore be indicative of a general risk that the driver associated with the first driver data set will be in an accident.

At step 310, the risk modeling system 110 may generate a first risk model based on the first route risk score and the first driver risk score. The risk modeling system 110 may generate the first risk model by inputting the first driver risk score and the first route risk into the trained machine learning engine. The first risk model may therefore be indicative of a risk that the driver associated with the first driver data will be in an accident along the route associated with the first route data set and/or that a cost will be associated with the accident to, for example, pay for repairs to a vehicle or the like. The first risk model may further include a suggested insurance rate for the driver and the route.

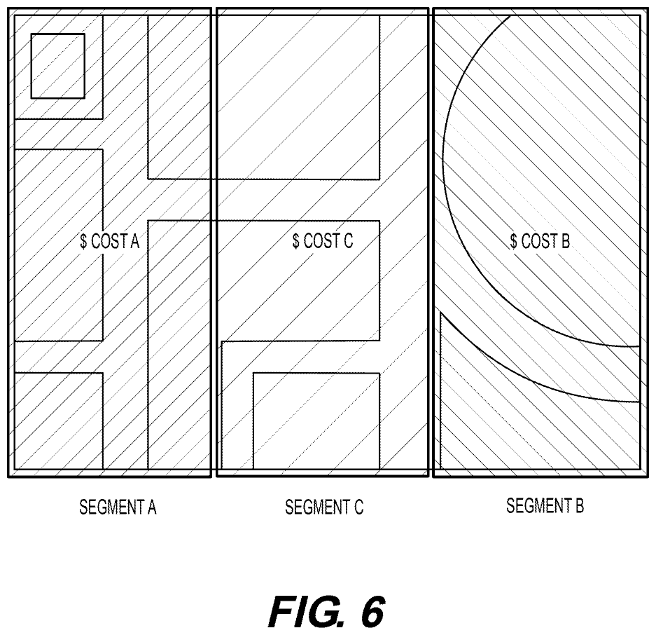

After generating the first risk model, the risk modeling system 110 may at step 312 cause a graphic representative of the first risk model to be displayed on an interface, such as, for example, a user interface of user device 105. The graphic displayed on the interface may take a variety of forms. For example, in some embodiments, the graphic may be a numerical cost to insure the driver along the route. In some embodiments, the graphic may indicate a relative risk of the driver driving the route using colors, a numerical ranking system, or the like. For example, the color red may indicate a relatively high risk whereas the color blue may indicate a relatively low risk. Alternatively, the graphic may show a numerical ranking on a predetermined scale, such as 0 to 100, where 100 represents a relatively high risk and 0 represents a relatively low risk. The predetermined scale need not extend from 0 to 100, however, as a predetermined scale with any upper and lower bounds could suffice. In some embodiments, the graphic may include an illustration or a satellite image of a map of the route with information indicative of the first risk model overlaid on the map. An example graphic will be described in further detail with respect to FIG. 6.

Alternatively, or in addition to causing a graphic to be displayed, the risk modeling system 110 may input or otherwise transmit the first risk model to a route selection system. The route selection system may be, for example, a navigation system or another type of driving system that is configured to select one or more routes for traveling from one location to another. The risk modeling system 110 may further repeat steps 304, 306, and 310 for a second route data set to generate a second risk model. The risk modeling system 110 may also input or otherwise transmit the second risk model to the route selection system. The route selection system may be configured to select one of the route associated with the first route data set and a route associated with the second route data set. The route selection system may be configured to make the selection based on the first risk model and the second risk model. Accordingly, the route selection system may account for risk along the routes when selecting one of the routes. In some embodiments, the route selection system may further select the route associated with less risk.

It is to be understood that process 300 as shown in FIG. 3 is presented herein in simplified form and may incorporate additional steps. For example, in addition to receiving a first route data set at step 304, the risk modeling system 110 may receive a second route data set associated with a second route, a third route data set associated with a third route, and any additional number of route data sets. In addition to generating the first route risk score at step 306, the risk modeling system 110 may then generate a second route risk score based on the second route data set, a third route risk score based on the third route data set, etc. In addition to generating a first risk model based on the first route risk score and the first driver risk score, the risk modeling system 110 may then generate a second risk model based on the second route risk score and the first driver risk score, a third risk model based on the third route risk score and the first driver risk score, etc. The risk modeling system 110 may then display multiple graphics, each representing one of the first risk score, the second risk score, the third risk score, etc. The risk modeling system 110 may alternatively display a graphic representative of all of the first risk model, second risk model, third risk model, etc.

As another example, in addition to receiving a first driver data set at step 302, the risk modeling system 110 may receive a second driver data set associated with a second driver, a third driver data set associated with a third driver, and any additional number of driver data sets. In addition to generating the first driver risk score at step 308, the risk modeling system 110 may then generate a second driver risk score based on the second driver data set, a third driver risk score based on the third driver data set, etc. In addition to generating a first risk model based on the first route risk score and the first driver risk score, the risk modeling system 110 may then generate a second risk model based on the first route risk score and the second driver risk score, a third risk model based on the first route risk score and the third driver risk score, etc. The risk modeling system 110 may then display multiple graphics, each representing one of the first risk model, the second risk model, the third risk model, etc. The risk modeling system 110 may alternatively display a graphic representative of all of the first risk score, second risk score, third risk score, etc.

As a result of the process 300, the risk modeling system 110 may generate, based on data associated with a driver and data associated with a route, a risk model indicative of a risk or cost to insure that particular driver to drive over that particular route. The process 300 further allows the risk modeling system 110 to cause display of a graphic visually indicative of that risk or cost to insure. In some embodiments, the risk modeling system 110 may produce one or more graphics which allow comparison of a risk and/or cost to insure a driver across multiple routes. In some embodiments, the risk modeling system 110 may produce one or more graphics which allow comparison of a risk and/or cost to insure multiple drivers across one or more routes. In some embodiments, the risk modeling system 110 may produce one or more graphics indicative of a recommendation to select a particular route from a plurality of routes. The recommendation may be based on a risk and/or cost to insure a driver across the plurality of routes. The recommendation may, for example, be to select a route from the plurality of routes with the lowest risk and/or the lowest cost to insure.

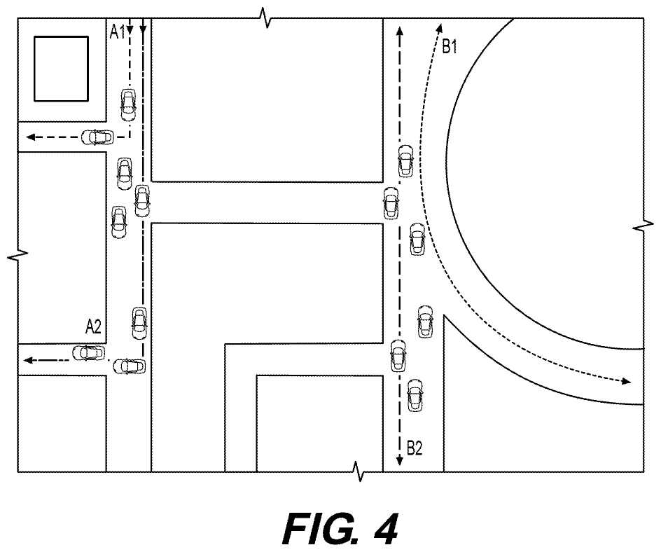

FIG. 4 depicts an example map in which a plurality of routes are indicated. The risk modeling system 110 may be configured to perform processes similar to the processes 200 and 300 described herein previously. For the sake of simplicity, the map in FIG. 4 shows only several roads. However, it is to be understood that a much larger map including many streets, roads, and highways may be used with some embodiments. In some embodiments, the risk modeling system 110 may use a map of an entire city or geographic region which includes thousands of routes.

As shown in FIG. 4, the map indicates a plurality of example routes, including route A1, route A2, route B1, and route B2. The risk modeling system 110 may receive a route data set associated with each of route A1, route A2, route B1, and route B2. The risk modeling system 110 may further receive a driver data set associated with a driver and perform a process similar to process 300, as described herein previously, to generate a risk model for the route and the driver, and display a representative graphic.

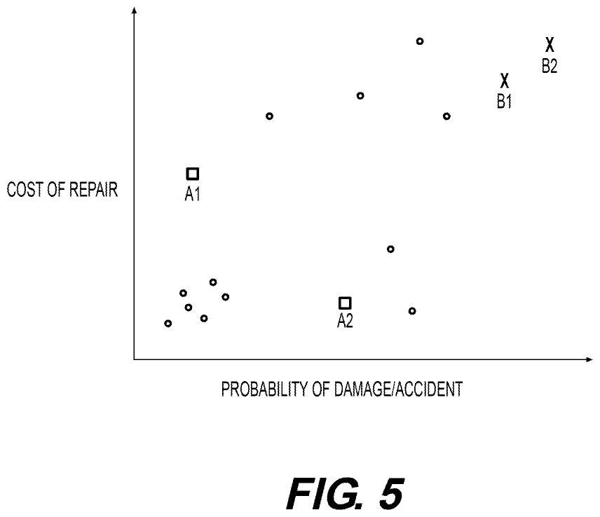

FIG. 5 depicts an example chart which plots a Cost of Repair and a Probability of Damage/Accident for each of route A1, route A2, route B1, and route B2. The chart in FIG. 5 may be representative of an analysis performed by the risk modeling system 110 in accordance with the processes described herein previously. The chart in FIG. 5 indicates that, for a particular driver, the probability of vehicle damage or an accident occurring while the driver drives along route A1 may be relatively low. The chart further indicates that should vehicle damage or an accident along route A1 occur, a cost of repairing the vehicle may be in a middle range. With respect to route A2, the chart indicates that the probability of vehicle damage or of an accident occurring while the driver drives along route A2 may be in a middle range, and that a cost of repairing the vehicle may be relatively low. With respect to routes B1 and B2, the chart indicates that the probability of vehicle damage or an accident occurring while the driver drives along either of routes B1 or B2 may be relatively high, and that a cost of repairing the vehicle may also be relatively high.

FIG. 6 depicts an example graphic that may be generated by the risk modeling system 110 for the map depicted in FIG. 4 according to the information shown in the graph of FIG. 5. The graphic may be displayed on an interface, such as a user interface of user device 105, as described herein previously. Based on the cost of repair and probability of damage or an accident for each of route A1, route A2, route B1, and route B3, the risk modeling system 110 may segment the map into segment A, segment B, and segment C. Segment A may cover a portion of the map through which route A1 and route A2 pass. Segment B may cover a portion of the map through which route B1 and route B2 pass. Segment C may cover a portion of the map through which no routes pass.

For route A1 and route A2, at least one of the cost of repair and the probability of damage or an accident is relatively low. The risk modeling system 110 may then determine that a cost to insure a particular driver for route A1 and route A2 would be relatively low. The risk modeling system 110 may further group route A1 and route A2 into segment A based on a geographic proximity of route A1 to route A2 and a similar relatively low cost to insure a particular driver along either route. The risk modeling system 110 may then associate Cost A with segment A as a cost to insure the driver to drive within segment A.

For route B1 and route B2, both of the cost of repair and the probability of damage or an accident is relatively high. The risk modeling system 110 may then determine that a cost to insure a particular driver for route B1 and route B2 would be relatively high. The risk modeling system 110 may further group, based on a geographic proximity of route B1 to route B2 and a similar relatively high cost to insure a particular driver along either route, route B1 and route B2 into segment B. The risk modeling system 110 may then associate Cost B with segment B as a cost to insure the driver to drive within segment B. Cost B may be higher than Cost A.

Segment C may be a segment which includes no identified routes or for which the risk modeling system 110 has not received any route data sets. Accordingly, the risk modeling system 110 may simply associate Cost C with segment C, where Cost C is a default cost to insure the driver over a segment for which data is lacking. Alternatively, Cost C may be extrapolated from costs associated with segments adjacent to or nearby Segment C. For example, Cost C may be determined based on Cost A, which is associated with segment A, and Cost B, which is associated with segment B. In some embodiments, Cost C may be a simple average of Cost A and Cost B.

In some embodiments, a user may be able to interact with a graphic such as the graphic shown in FIG. 6 via an interface. For example, a driver viewing such a graphic may be prompted via a user interface of user device 105 to select whether she would like to purchase insurance for any of segment A, segment B, or segment C. In a case where the user is a ridesharing driver, the user may be prompted to select or decline rides based on the information shown in the graphic. In some embodiments, the risk modeling system 110 may rank segment A, segment B, and segment C based on the costs to insure the driver for those segments and display the ranking. In some embodiments, the interface may display information relating to the first driver data set and the first route data set upon selection of the graphic by a user.

In some embodiments, the graphic may be displayed for an insurer interested in selling insurance to drivers. An insurer may be prompted to sell insurance to a particular driver for a particular segment at a fixed cost, or alternatively may be prompted to submit an asking price for the insurance. Multiple insurers may compete against each other to offer a particular driver the lowest price for a particular segment.

It is to be understood that the graphic shown in FIG. 6 is based on the simplified map of FIG. 4 and accordingly, in some embodiments, a significantly larger map may be depicted in the graphic. Additionally, the risk modeling system 110 may divide the map into many more segments than are shown in FIG. 6.

Several attributes of embodiments according to the present disclosure can be readily recognized. In general, some embodiments allow for the segmentation of insurance coverage over geographical areas based on data specific to those geographical areas and data specific to a driver, or a prospective insurance buyer. Additionally, some embodiments allow for insurance rates to be set with increased precision with respect to both a driver and geographical areas within which a driver may choose to be insured. Further, some embodiments may allow for drivers to be linked with insurers with varying risk tolerances, allowing the insurers to sell insurance for particular segments matching their risk preferences.

For rideshare drivers seeking to generate income from driving, the foregoing attributes may be particularly salient. Some embodiments may allow rideshare drivers to be selective about segments and routes for which they purchase insurance. For example, a rideshare driver may choose to purchase insurance only for segments or routes for which the cost of insurance is relatively low. The rideshare driver may further choose to only perform rideshare services within those segments or along those routes. As a result, the rideshare driver may decrease her overhead and generate more profit from providing the ridesharing services.

Further aspects of the disclosure are discussed in the additional embodiments below. It should be understood that embodiments in this disclosure are exemplary only, and that other embodiments may include various combinations of features from other embodiments, as well as additional or fewer features.

In general, any process discussed in this disclosure that is understood to be computer-implementable, such as the processes illustrated in FIGS. 2 and 3, may be performed by one or more processors of a computer system. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system may include one or more computing devices. If the one or more processors of the computer system are implemented as a plurality of processors, the plurality of processors may be included in a single computing device or distributed among a plurality of computing devices. If a computer system comprises a plurality of computing devices, the memory of the computer system may include the respective memory of each computing device of the plurality of computing devices.

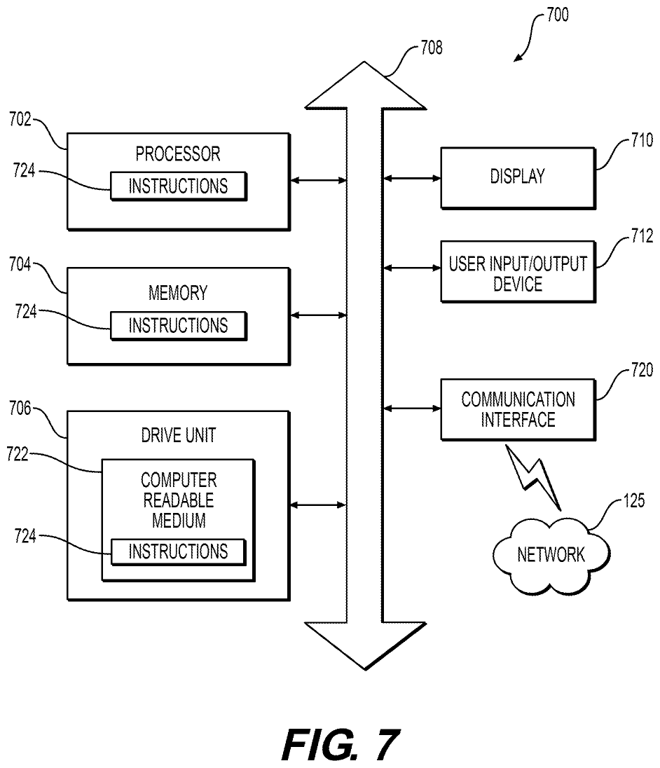

FIG. 7 is a simplified functional block diagram of a computer system 700 that may be configured as a device for executing the processes of FIGS. 2 and 3, according to exemplary embodiments of the present disclosure. FIG. 7 is a simplified functional block diagram of a computer that may be configured to serve as any of the user device 105, the risk modeling system 110, or the databases 115, according to exemplary embodiments of the present disclosure. In various embodiments, any of the systems herein may be an assembly of hardware including, for example, a data communication interface 720 for packet data communication. The platform also may include a central processing unit (“CPU”) 702, in the form of one or more processors, for executing program instructions. The platform may include an internal communication bus 708, and a storage unit 706 (such as ROM, HDD, SDD, etc.) that may store data on a computer readable medium 722, although the system 700 may receive programming and data via network communications including via network 125. The system 700 may also have a memory 704 (such as RAM) storing instructions 724 for executing techniques presented herein, although the instructions 724 may be stored temporarily or permanently within other modules of system 700 (e.g., processor 702 and/or computer readable medium 722). The system 700 also may include input and output ports 712 and/or a display 710 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to generating route risk models for vehicular travel using a machine learning engine, it should be appreciated that the presently disclosed embodiments may be applicable to generating risk models using a machine learning engine for any other purpose.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to: the processes depicted in FIGS. 2 and 3 and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for generating and displaying models for routes using a machine learning engine, the method comprising:
receiving, by one or more processors, a plurality of route data sets, wherein each route data set in the plurality of route data sets is associated with a route, and wherein each route data set includes associated collision data;
determining, by the one or more processors, a route score for each of the associated routes;
receiving, by the one or more processors, a plurality of driver data sets, wherein each driver data set in the plurality of driver data sets is associated with a driver, and wherein each driver data set comprises a driver history for a driver;
determining, by the one or more processors, a driver score for each of the associated drivers;
generating, by the one or more processors, a model for each driver and each route based on a respective driver score and a respective route score;
grouping the plurality of the route data sets, by the one or more processors, into one or more clusters of route data sets based on the model;
for each of the one or more clusters, training a neural network, by the one or more processors, to associate the cluster with one or more sequential patterns found within the cluster, based on one or more route data sets in the cluster of the plurality of route data sets, to generate a trained neural network;
receiving a first driver data set and a first route data set, wherein the first driver data set is associated with a first driver, and the first route data set is associated with a first route of the first driver;
inputting, by the one or more processors, the first driver data set and the first route data set into the trained neural network;
generating, using the trained neural network, by the one or more processors, a first route score based on the first route data set and a first driver score based on the first driver data set;
generating, using the trained neural network, by the one or more processors, a first model based on the first route score and the first driver score; and
causing display, by the one or more processors, of a graphic representing the first model on an interface.

2. The method of claim 1, wherein each route data set in the plurality of route data sets further comprises one or more of location data, collision repair cost data, weather data, collision type data, or vehicle data.

3. The method of claim 1, wherein the first model further comprises a suggested insurance rate for the first driver for the first route.

4. The method of claim 1, wherein a second route data set is associated with a second route of the first driver.

5. The method of claim 4, further comprising:
generating, using the trained neural network, by the one or more processors, a second route score based on the second route data set;
generating, using the trained neural network, by the one or more processors, a second model based on the second route score and the first driver score; and
causing display, by the one or more processors, of a graphic representing the second model on the interface.

6. The method of claim 5, wherein the interface is configured to present a graphic representing the first and second routes.

7. The method of claim 5, wherein the graphic representing the first and second models on the interface are configured for user interaction.

8. The method of claim 5, further comprising:
generating, using the trained neural network, by the one or more processors, a first cost to insure the first route based on the first model;
generating, by the one or more processors, using the trained neural network, a second cost to insure the second route based on the second model;
ranking the first and second models based on the first and second costs to insure the first and seconds routes; and
causing display of a graphic representing the ranking on the interface.

9. The method of claim 1, wherein the interface displays information relating to the first driver history and the first route data upon selection of a graphic representing the first model displayed on the interface.

10. The method of claim 1, wherein the driver history comprises one or more of: prior collision data, prior police citation data, or driving performance data.

11. A computer system for generating and displaying models for routes using a machine learning engine, the system comprising:
a memory storing processor-readable instructions; and
at least one processor configured to access the memory and execute the processor-readable instructions, which when executed by the at least one processor configures the at least one processor to perform a plurality of functions, including functions for:
receiving a plurality of route data sets, wherein each route data set in the plurality of route data sets is associated with a route, and wherein each route data set includes associated collision data and collision repair cost data;
determining a route score for each of the associated routes;
receiving a plurality of driver data sets wherein each driver data set in the plurality of driver data sets is associated with a driver, and wherein each driver data set comprises a driver history for a driver;
determining a driver score for each of the associated drivers;
generating a model for each driver and each route based on a respective driver score and a respective route score;
grouping the plurality of the route data sets into one or more clusters of route data sets based on the model;
for each of the one or more clusters, training a neural network to associate the cluster with one or more sequential patterns found within the cluster, based on one or more route data sets in the cluster of the plurality of route data sets, to generate a trained neural network;
receiving a first driver data set and a first route data set, wherein the first driver data set is associated with a first driver, and the first route data set is associated with a first route of the first driver;
inputting the first driver data set and the first route data set into the trained neural network;
generating, using the trained neural network, a first route score based on the first route data set and a first driver score based on the first driver data set;
generating, using the trained neural network, a first model based on the first route score and the first driver score; and
causing display of a graphic representing the first model on an interface.

12. The computer system of claim 11, wherein each route data set in the plurality of route data sets further comprises one or more of location data, weather data, collision type data, or vehicle data.

13. The computer system of claim 11, wherein a second route data set is associated with a second route of the first driver.

14. The computer system of claim 13, wherein the functions further include:
generating, using the trained neural network, a second route score based on the second route data set;
generating, using the trained neural network a second model based on the second route score and the first driver score; and
causing display of a graphic representing the second model on the interface.

15. The computer system of claim 14, wherein the interface is configured to present a graphic representing the first and second routes.

16. The computer system of claim 14, wherein the graphics representing the first and second models displayed on the interface are configured for user interaction.

17. The computer system of claim 14, wherein the functions further include:
generating, using the trained neural network, by the one or more processors, a first cost to insure the first route based on the first model;
generating, using the trained neural network, a second cost to insure the second route based on the second model;
ranking the first and second models based on the first and second costs to insure the first and second routes; and
causing display of a graphic representing the ranking on the interface.

18. The computer system of claim 11, wherein the interface is configured to display information relating to the first driver history and the first route data upon selection of a graphic representing the first model displayed on the interface.

19. The computer system of claim 11, wherein the driver history comprises one or more of: prior collision data, prior police citation data, or driving performance data.

20. A computer-implemented method for generating and displaying models for routes using a machine learning engine, the method comprising:
receiving, by one or more processors, a plurality of route data sets, wherein each route data set in the plurality of route data sets is associated with a route, and wherein each route data set includes associated collision data and collision repair cost data;
determining, by the one or more processors, a route score for each of the associated routes;
receiving, by the one or more processors, a plurality of driver data sets wherein each driver data set in the plurality of driver data sets is associated with a driver, and wherein each driver data set comprises a driver history for a driver;
determining, by the one or more processors, a driver score for each of the associated drivers;
generating, by the one or more processors, a model for each driver and each route based on a respective driver score and a respective route score;
grouping the plurality of the route data sets, by the one or more processors, into one or more clusters of route data sets based on the model;
for each of the one or more clusters, training a neural network, by the one or more processors, to associate the cluster with one or more sequential patterns found within the cluster, based on one or more route data sets in the cluster of the plurality of route data sets, to generate a trained neural network;
receiving a first driver data set and a first route data set, wherein the first driver data set is associated with a first driver, and the first route data set is associated with a first route of the first driver;
inputting, by the one or more processors, the first driver data set and the first route data set into the trained neural network;
generating, using the trained neural network, by the one or more processors, a first route score based on the first route data set and a first driver score based on the first driver data set;
generating, using the trained neural network, by the one or more processors, a first model based on the first route score and the first driver score;
receiving a second route data set, wherein the second route data set is associated with a second route of the first driver;
inputting, by the one or more processors, the first driver data set and second route data set into the trained neural network;
generating, using the trained neural network, by the one or more processors, a second route score based on the second route data set;
generating, using the trained neural network, by the one or more processors, a second model based on the second route score and the first driver score; and
inputting or transmitting the first model and the second model to a route selection system, the route selection system being configured to select one of the first route and the second route based on the first model and the second model.
